(19) United States
(12) Patent Application Publication
(10) Pub. No.: US 2018/0016179 A1
(43) Pub. Date: Jan. 18, 2018

(54) A GLASS-CARRIER ASSEMBLY AND METHODS FOR PROCESSING A FLEXIBLE GLASS SHEET

(71) Applicant: CORNING INCORPORATED, CORNING, NY (US)

(72) Inventors: Erin Kathleen Canfield, Corning, NY (US); Todd Benson Fleming, Elkland, PA (US); Xinghua Li, Horseheads, NY (US); Anping Liu, Horseheads, NY (US); Leonard Thomas Masters, Painted Post, NY (US)

(21) Appl. No.: 15/541,938

(22) PCT Filed: Jan. 6, 2016
(86) PCT No.: PCT/US16/12300

§ 371 Date: Jul. 6, 2017

Related U.S. Application Data
(60) Provisional application No. 62/100,232, filed on Jan. 6, 2015.

(51) Int. Cl. C03B 33/03; B32B 17/06; B32B 7/06; B32B 38/00; C03B 33/09; C03B 33/033

(52) U.S. Cl. CPC C03B 33/03; C03B 33/091; C03B 33/033; B32B 7/06; B32B 38/105; B32B 17/06; B32B 2309/105

(57) ABSTRACT

A method of processing a flexible glass sheet having a thickness of equal to or less than 300 μm includes separating an outer edge portion of the flexible glass sheet from a bonded portion of the flexible glass sheet along a separation path while the bonded portion of the flexible glass sheet remains bonded with respect to a first major surface of a carrier substrate. The step of separating the outer edge portion provides the flexible glass sheet with a new outer edge extending along the separation path. A lateral distance between the new outer edge of the flexible glass sheet and an outer periphery of the first major surface of the carrier substrate is equal to or less than about 750 μm.

### CROSS-REFERENCE TO RELATED APPLICATIONS

This application claims the benefit of priority under 35 U.S.C. §119 of U.S. Provisional Application Ser. No. 62/100,232 filed on Jan. 6, 2015, the content of which is relied upon and incorporated herein by reference in its entirety.

### FIELD

The present disclosure relates generally to methods for processing a flexible glass sheet and, more particularly, to methods for processing a flexible glass sheet including separating an outer edge portion from a bonded portion of the flexible glass sheet while the flexible glass sheet is bonded with respect to a first major surface of a carrier substrate.

### BACKGROUND

There is interest in using thin, flexible glass ribbon in the fabrication of flexible electronics or other devices. Flexible glass sheets separated from the flexible glass ribbon can provide several beneficial properties related to either the fabrication or performance of electronic devices, for example, liquid crystal displays (LCDs), electrophoretic displays (EPD), organic light emitting diode displays (OLEDs), plasma display panels (PDPs), touch sensors, photovoltaics, etc. One component in the use of flexible glass ribbon is the ability to handle flexible glass sheets separated from the flexible glass ribbon.

To enable the handling of a flexible glass sheet during processing procedures, the flexible glass sheet is typically bonded to a rigid carrier substrate using a binding agent. Once bonded to the carrier substrate, the rigid characteristics and size of the carrier substrate allow the bonded structure to be handled in production without bending or causing damage to the flexible glass sheet. For example, thin-film transistor (TFT) components may be attached to the flexible glass sheet in the production of LCDs while the flexible glass sheet is bonded to the rigid carrier substrate. After processing, the flexible glass sheet can be removed from the carrier substrate.

After removing the flexible glass sheet from the carrier substrate, there is a desire to recycle the carrier substrate for future processing procedures with additional flexible glass sheets. However, current techniques of trimming the flexible glass sheet to size prior to bonding the trimmed flexible glass sheet to the carrier substrate typically generate glass particles that may contaminate the first major surface of the carrier substrate, thereby diminishing or destroying the utility of the carrier substrate for current or future processing procedures. Additionally, trimming the flexible glass sheet to size prior to bonding the trimmed flexible glass sheet to the carrier substrate may generate glass particles that contaminate the second major surface of the flexible glass sheet, which may give rise to problems in: reducing the strength of the bond between the flexible glass sheet and the carrier substrate; providing a path for ingress of process liquids into the flexible glass sheet/carrier interface during the processing of devices onto the flexible glass sheet; and/or debonding the flexible glass sheet from the carrier substrate as when the glass particles provide a bonding mechanism between the flexible glass sheet and the carrier, which bonding mechanism may lead to damage to the flexible glass sheet and/or carrier during a debonding process. Furthermore, there is a desire to provide a predetermined lateral distance between corresponding outer edges of the flexible glass sheet and the carrier substrate. However, current techniques of trimming the flexible glass sheet to size prior to bonding complicates precise positioning and bonding of the trimmed flexible glass sheet to the carrier substrate to achieve the predetermined lateral distance and/or a lateral distance within a predetermined range of lateral distances. Accordingly, there is a need for practical solutions for processing thin, flexible glass sheets.

### SUMMARY

There are set forth methods configured to provide a flexible glass sheet bonded to a carrier substrate while preserving the utility of the carrier substrate for future processing procedures. Methods of the disclosure also simplify relative positioning between the edge(s) of the flexible glass sheet and the respective edge(s) of the carrier substrate by separating an outer edge of a bonded portion of the flexible glass sheet while the flexible glass sheet is bonded to the carrier substrate. In such a manner, a difficult task of aligning of a pre-trimmed flexible glass sheet with a carrier substrate can be avoided. Rather, an oversized flexible glass sheet may first be bonded with respect to the carrier substrate and then subsequently trimmed to a predetermined size and alignment. Accordingly, in some examples, the flexible glass sheet and the carrier substrate easily may be sized so that the flexible glass sheet is smaller than the carrier by up to 750 μm, at each point around the perimeter of the carrier.

In one example aspect, a method of processing a flexible glass sheet includes the step (I) of providing a flexible glass sheet including a first major surface and a second major surface opposing the first major surface. The second major surface of the flexible glass sheet is bonded with respect to a first major surface of a carrier substrate and an outer edge portion of the flexible glass sheet protrudes beyond an outer periphery of the first major surface of the carrier substrate. A thickness between the first major surface and the second major surface of the flexible glass sheet is equal to or less than about 300 μm. The method then includes the step (II) of separating the outer edge portion from a bonded portion of the flexible glass sheet along a separation path while the bonded portion of the flexible glass sheet remains bonded with respect to the first major surface of the carrier substrate. The step of separating the outer edge portion provides the flexible glass sheet with a new outer edge extending along the separation path. A lateral distance between the new outer edge of the flexible glass sheet and the outer periphery of the first major surface of the carrier substrate is equal to or less than about 750 μm.

In one example of the aspect, step (I) further includes bonding the second major surface of the flexible glass sheet with respect to the first major surface of the carrier substrate. The second major surface of the flexible glass sheet that is bonded during step (I) has a larger surface area than a surface area of the first major surface of the carrier substrate. In one particular example, bonding during step (I) laterally circumscribes the first major surface of the carrier substrate with the outer edge portion of the flexible glass sheet.

In another example of the aspect, step (II) includes providing at least one defect in at least one of the first major surface and the second major surface of the flexible glass sheet on the separation path.

In one particular example of the aspect, the at least one defect includes a plurality of defects in the first major surface of the flexible glass sheet, and the plurality of defects are spaced apart from one another along the separation path. In one example, each defect of the plurality of defects extends from the first major surface to a depth below the first major surface of less than or equal to 20% of the thickness of the flexible glass sheet. In another example, the space between adjacent defects of the plurality of defects is within a range of from about 15 μm to about 25 μm. In still another example, step (II) further includes traversing a beam of electromagnetic radiation over the first major surface along the separation path to: (a) transform at least one of the plurality of defects into a full body crack intersecting the first major surface and the second major surface of the flexible glass sheet; and (b) propagate the full body crack through remaining defects of the plurality of defects along the separation path, thereby producing a full body separation of the outer edge portion from the bonded portion of the flexible glass sheet while the second major surface of the flexible glass sheet remains bonded to the first major surface of the carrier substrate.

In another particular example of the aspect, the at least one defect is provided in the second major surface of the flexible glass sheet and step (II) further includes traversing a beam of electromagnetic radiation over the first major surface along the separation path to: (a) transform the at least one defect into a full body crack intersecting the first major surface and the second major surface of the flexible glass sheet; and (b) propagate the full body crack through along the separation path, thereby producing a full body separation of the outer edge portion from the bonded portion of the flexible glass sheet while the second major surface of the flexible glass sheet remains bonded to the first major surface of the carrier substrate.

In yet another particular example of the aspect, step (II) further includes traversing a beam of electromagnetic radiation over the first major surface followed by a cooling stream of fluid along the separation path to: (a) transform the at least one defect into a full body crack intersecting the first major surface and the second major surface of the flexible glass sheet; and (b) propagate the full body crack along the separation path, thereby producing a full body separation of the outer edge portion from the bonded portion of the flexible glass sheet while the second major surface of the flexible glass sheet remains bonded to the first major surface of the carrier substrate. In one example, the at least one defect is provided in the first major surface of the flexible glass sheet.

In still another particular example, the at least one defect includes a scribe line in the first major surface of the flexible glass sheet along the separation path and wherein step (II) further includes applying a bending force to the outer edge portion to separate the outer edge portion from the bonded portion of the flexible glass sheet.

In a further example of the aspect, during step (II), the outer edge portion is bent relative to the bonded portion of the flexible glass sheet to place in tension the first major surface of the flexible glass sheet along the separation path.

In yet a further example of the aspect, the new outer edge of the flexible glass sheet has a B10 strength within a range of from about 150 MPa to about 200 MPa.

In still a further example of the aspect, the new outer edge of the flexible glass sheet laterally extends beyond the outer periphery of the first major surface of the carrier substrate.

In another example of the aspect, the outer periphery of the first major surface of the carrier substrate laterally extends beyond the new outer edge of the flexible glass sheet.

In another example of the aspect, the outer periphery of the first major surface of the carrier substrate laterally extends beyond the new outer edge of the flexible glass sheet by a distance up to about 250 μm.

In yet another example of the aspect, step (I) provides the second major surface of the flexible glass sheet with a larger surface area than a surface area of the first major surface of the carrier substrate. In one particular example, step (I) provides that the outer edge portion of the flexible glass sheet laterally circumscribes the first major surface of the carrier substrate.

In a further example of the aspect, after step (II), the method further includes the step (III) of releasing at least a portion of the flexible glass sheet from the carrier substrate by producing a concave curvature in the first major surface of the flexible glass sheet.

The aspect may be provided alone or in combination with any one or more of the examples of the aspect discussed above.

### BRIEF DESCRIPTION OF THE DRAWINGS

The above and other features, aspects and advantages of the present invention are better understood when the following detailed description of the invention is read with reference to the accompanying drawings, in which:

FIG. 1 is a perspective view of the flexible glass sheet bonded to the carrier substrate to form a glass-carrier assembly;

FIG. 2 is a top view of the glass-carrier assembly of FIG. 1;

FIG. 3 is an enlarged view of a portion of the glass-carrier assembly at view 3 of FIG. 1;

FIG. 4 is an enlarged view of a portion of a glass-carrier assembly in accordance with another embodiment of the disclosure;

FIG. 5 is an enlarged view of a portion of a glass-carrier assembly in accordance with still another embodiment of the disclosure;

FIG. 6 illustrates a method of bonding the flexible glass sheet to the carrier substrate;

FIG. 7 illustrates an oversized flexible glass sheet bonded to the carrier substrate;

FIG. 8 is an enlarged view of a portion of an outer edge portion of the flexible glass sheet taken at view 8 of FIG. 7;

FIG. 9 is a plan view of the first major surface of the flexible glass sheet showing example separation paths;

FIG. 10 is a partial enlarged view long line 10-10 of FIG. 9;

FIG. 11 illustrates an example method of separating the outer edge portion of the glass ribbon by forming a plurality of defects in the first major surface of the flexible glass sheet;

FIG. 12 is a partial enlarged sectional view along line 12-12 of FIG. 11 illustrating at least one of the plurality of defects being transformed into a full body crack;

FIG. 13 illustrates propagating the full body crack through a plurality of defects of FIG. 11;

FIG. 14 is a sectional view along line 14-14 of FIG. 13 showing the full body crack propagating through the plurality of defects;

FIG. 15 is an enlarged view of a new outer edge formed by the full body crack of FIG. 14;

FIG. 16 is a Weibull distribution chart of strength of separated outer edge portions of the flexible glass sheets that were separated by a method similar to the method shown in FIGS. 11-15, and then subject to a two point bend test;

FIG. 17 illustrates another example method of separating the outer edge portion of the glass ribbon by forming a defect in the first major surface of the flexible glass sheet;

FIG. 18 is a partial enlarged side view of FIG. 17 illustrating formation of the defect in the first major surface of the flexible glass sheet;

FIG. 19 is a partial enlarged side view similar to FIG. 18 but showing the defect being transformed into a full body crack;

FIG. 20 illustrates propagating the full body crack along the separation path of FIG. 17;

FIG. 21 is a sectional view along line 21-21 of FIG. 20 showing the full body crack propagating along the separation path;

FIG. 22 is a Weibull distribution chart of strength of separated outer edge portions of the flexible glass sheets that were separated by a method similar to the method shown in FIGS. 17-21, and then subject to a two point bend test;

FIG. 23 illustrates still another example method of separating the outer edge portion of the glass ribbon by forming a defect in the second major surface of the flexible glass sheet;

FIG. 24 illustrates a view similar to FIG. 23 but showing the defect being transformed into a full body crack;

FIG. 25 illustrates propagating the full body crack along a separation path;

FIG. 26 is a sectional view along line 26-26 of FIG. 25 showing the full body crack propagating along the separation path;

FIG. 27 illustrates yet another example method of separating the outer edge portion of the glass ribbon by forming a scribe line in the first major surface of the flexible glass sheet;

FIG. 28 illustrates breaking away the outer edge portion from the bonded portion of the flexible glass sheet along the scribe line; and

FIG. 29 illustrates a method of at least partially peeling an edge of the flexible glass sheet from the carrier substrate.

### DETAILED DESCRIPTION

The present invention will now be described more fully hereinafter with reference to the accompanying drawings in which example embodiments of the claimed invention are shown. Whenever possible, the same reference numerals are used throughout the drawings to refer to the same or like parts. However, the claimed invention may be embodied in many different forms and should not be construed as limited to the embodiments set forth herein. These example embodiments are provided so that this disclosure will be both thorough and complete, and will fully convey the scope of the claimed invention to those skilled in the art.

Methods of processing a flexible glass sheet can provide a glass-carrier assembly 101 including a flexible glass sheet 103 including a first major surface 105 and a second major surface 107 opposing the first major surface 105. A thickness “T1” between the first major surface 105 and the second major surface 107 is equal to or less than about 300 μm, for example equal to or less than about 250 μm, for example equal to or less than about 200 μm, for example equal to or less than about 150 μm, for example equal to or less than about 100 μm, for example equal to or less than about 50 μm. In one example, the thickness T1 can be within a range of from about 50 μm to about 300 μm, for example from about 50 μm to about 250 μm, for example from about 50 μm to about 200 μm, for example from about 50 μm to about 150 μm, for example from about 50 μm to about 100 μm. In further examples, the thickness T1 can be within a range of from about 100 μm to about 300 μm, for example from about 100 μm to about 250 μm, for example from about 100 μm to about 200 μm, for example from about 100 μm to about 150 μm. In still further examples, the thickness T1 can be within a range of from about 150 μm to about 300 μm, for example from about 150 μm to about 250 μm, for example from about 150 μm to about 200 μm. In yet further examples, the thickness T1 can be within a range of from about 200 μm to about 300 μm, for example from about 200 μm to about 250 μm, for example from about 250 μm to about 300 μm.

The flexible glass sheet 103 can include at least one edge to provide the flexible glass sheet with a curvilinear (e.g., oval, circular, etc.) or polygonal (e.g., triangular, rectangular for example square, etc.) shape. For instance, as illustrated in FIG. 2, the flexible glass sheet 103 can further include four new outer edges 201, 203, 205, 207 produced by methods of the disclosure as discussed more fully below. The four new outer edges 201, 203, 205, 207 define the boundaries of the first major surface 105 and the second major surface 107 that may be arranged in the illustrated square shape although other shapes may be provided in further examples, for example, rectangular, polygonal, oval, or curvilinear.

The thin (i.e., less than or equal to 300 μm), flexible glass sheets 103 can be transparent and provide high optical transmission. The thin, flexible glass sheets 103 can further provide low surface roughness, high thermal and dimensional stability and a relatively low coefficient of thermal expansion. Therefore, thin, flexible glass sheets 103 can provide several beneficial properties related to either the fabrication or performance of electronic devices, for example, liquid crystal displays (LCDs), electrophoretic displays (EPD), organic light emitting diode displays (OLEDs), plasma display panels (PDPs), touch sensors, photovoltaics, etc. Thin, flexible glass sheets of the present disclosure can be fabricated in any number of ways including down-drawn, up-draw, float, fusion, press rolling, or slot draw, glass forming process or other techniques. The flexible glass sheets may then be separated from the glass ribbon in process as the glass ribbon is being formed from the glass forming process. Alternatively, the flexible glass sheets may be separated from the glass ribbon at a different time or location (e.g., from a roll of previously-formed glass ribbon). Example thin, flexible glass sheets may be formed from Corning® Willow® glass available from Corning, Inc. although other types of thin, flexible glass sheets may be used in further examples of the disclosure.

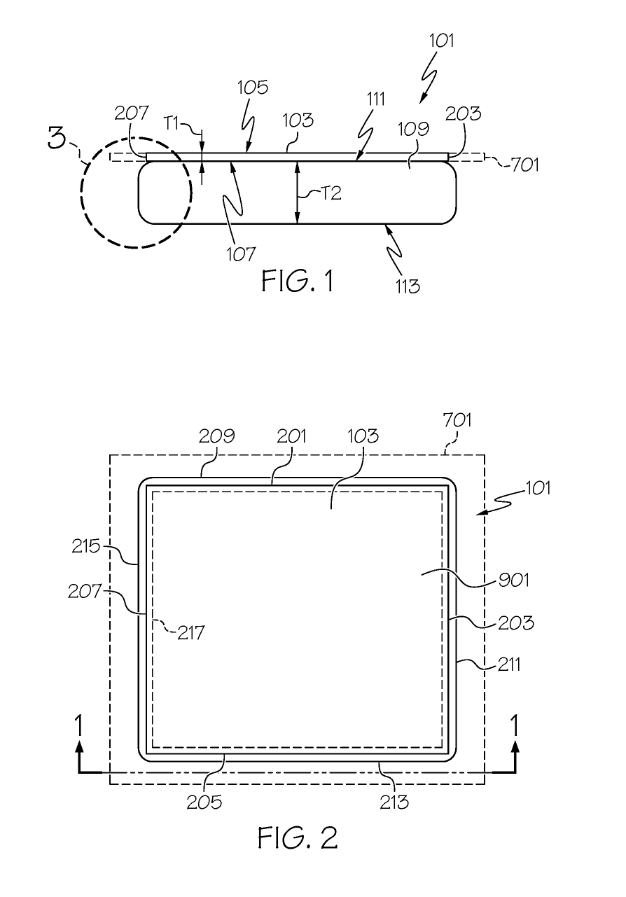

As further illustrated in FIG. 1, the glass-carrier assembly 101 further includes a carrier substrate 109 with a first major surface 111 and a second major surface 113 opposing the first major surface 111. A thickness “T2” between the first major surface 111 and the second major surface 113 is generally greater than the thickness T1, and may be from about 400 μm to about 1 mm, for example from about 400 μm to about 700 μm, for example from about 400 μm to about 600 μm although other thickness ranges may be used in further examples. The carrier substrate 109 may be provided as a wide range of materials for example glass, ceramic, glass ceramic or other materials. Depending on processing techniques or other requirements, the carrier substrate 109 may or may not transmit light and can therefore be at least partially or entirely transparent, translucent or opaque.

As further illustrated in FIG. 2, the carrier substrate 109 further includes outer edges 209, 211, 213, 215 that define an outer periphery 217 of the first major surface 111 of the carrier substrate 109. For purposes of this application, the outer edges include the outermost surface 301 together with any beveled portions 303a, 303b. As such, the outer periphery 217 of the first major surface 111 is considered the boundary where first major surface 111 begins to transition to the outer edge. In some examples, the outer periphery 217 can be a relatively sharp corner (e.g., 90° corner) where there is substantially no beveled portion but only the outermost surface 301 (e.g., a substantially flat outermost surface). Furthermore, as shown, in applications with a substantially flat first major surface 111, the outer periphery 217 of the substantially flat first major surface 111 can be considered the boundary where the carrier substrate 109 leaves the plane of the substantially flat first major surface 111. In some examples, the beveled portions may be provided to reduce stress concentrations. In one example, where the carrier substrate 109 has a thickness “T2” of about 500 μm, the lateral distance 305 between the outermost surface 301 and the outer periphery 217 can be from about 150 μm to about 250 μm although other distances 305 (e.g., from about 50 μm to about 750 μm) are possible depending on the thickness of the carrier substrate and other process considerations. In other embodiments, as wherein there is a relatively sharp corner for example, the distance 305 may be less than 50 microns, or close to zero, i.e., the outermost surface 301 may be substantially adjacent to the outer periphery 217.

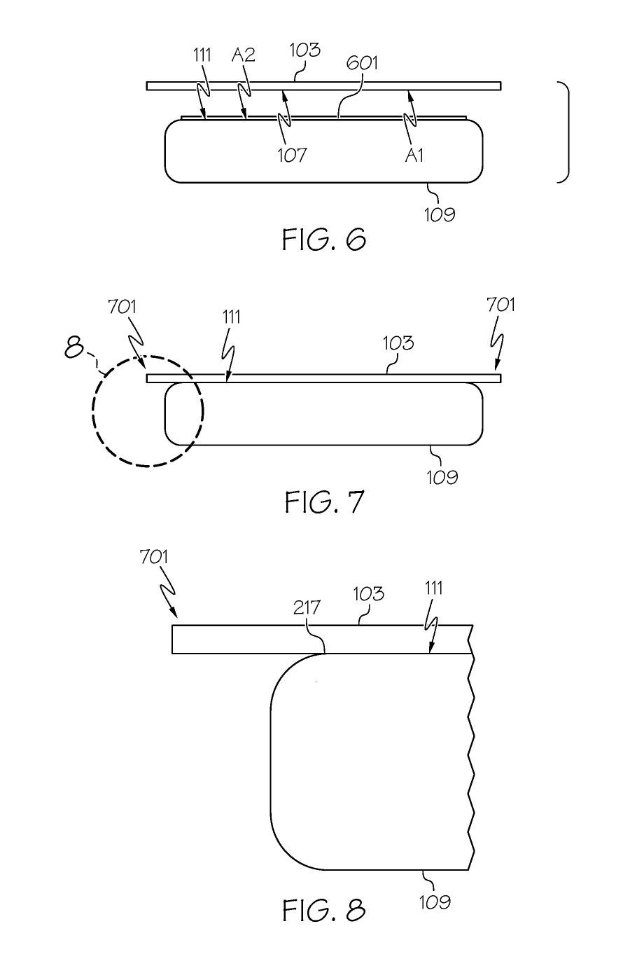

As shown in FIGS. 1-5, the second major surface 107 of the flexible glass sheet 103 may be removably bonded with respect to the first major surface 111 of the carrier substrate 109, thus forming the glass-carrier assembly 101. For instance, in one example, a layer of adhesive material (see 601 in FIG. 6) may be used to removably (or temporarily) bond the second major surface 107 of the flexible glass sheet 103 to the first major surface 111 of the carrier substrate 109. Moreover, other bonding techniques, for example, controlled hydrogen bonding may be used to temporarily bond the second major surface 107 of the flexible glass sheet 103 to the first major surface 111 of the carrier substrate 109. The adhesive layer (or other bonding feature) may extend the entire length “L1” and may even extend over the entire surface area “A2” such that the entire first major surface 111 is bonded to the second major surface 107 of the flexible glass sheet 103. In further examples, the adhesive layer (or other bonding feature) may extend a length “L2” that is less than the length “L1” such that only a central portion of the first major surface 111 is bonded to the second major surface 107 of the flexible glass sheet 103.

In some examples, the carrier substrate 109 may have a geometrically similar or identical peripheral shape to the flexible glass sheet 103. For example, although not shown, the carrier substrate 109 has an outer square shape that can be identical to the outer square shape of the flexible glass sheet 103. In further examples, the carrier substrate 109 may have a shape that, although not identical, is geometrically similar to the shape of the flexible glass sheet 103. For instance, as shown in the example embodiments of FIGS. 1-4, the carrier substrate 109 may have a shape that is larger but geometrically similar to the shape of the flexible glass sheet 103. Providing a larger carrier substrate 109 can help protect the relatively fragile new outer edges 201, 203, 205, 207 of flexible glass sheet 103 from damage. In this instance, the flexible glass sheet 103 may be smaller than the carrier substrate 109 (around the entire periphery of the carrier substrate 109) by up to about 750 microns, for example up to about 650 μm, for example up to about 550 μm, for example up to about 450 μm, for example up to about 350 μm, for example up to about 250 μm, for example up to about 150 μm, for example up to about 50 μm. Furthermore, as shown in the embodiment of FIG. 5, in some examples, the carrier substrate 109 may also have a shape that is smaller than the flexible glass sheet 103.

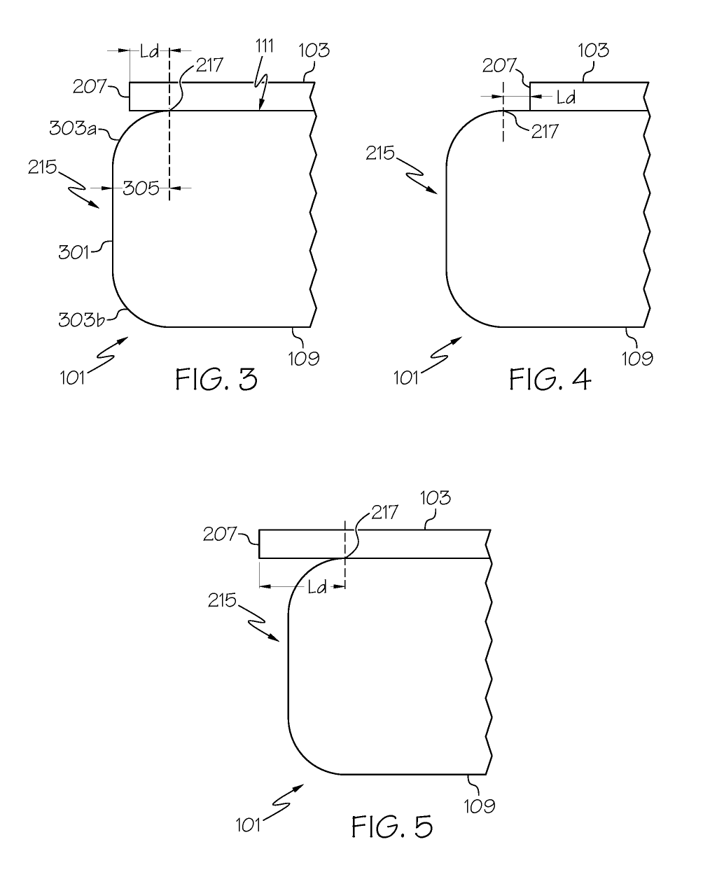

More specifically, with reference to FIG. 3, methods of the disclosure a lateral distance “Ld” between the new outer edge of the flexible glass sheet and the outer periphery 217 of the first major surface 111 of the carrier substrate 109 is equal to or less than about 750 μm, for example less than about 650 μm, for example less than about 550 μm, for example less than about 450 μm, for example less than about 350 μm, for example less than about 250 μm, for example less than about 150 μm, for example less than about 50 μm.

In some examples, the lateral distance “Ld” can be within a range of from about 0 μm to about 750 μm, for example from about 0 μm to about 650 μm, for example from about 0 μm to about 550 μm, for example from about 0 μm to about 450 μm, for example from about 0 μm to about 350 μm, for example from about 0 μm to about 250 μm, for example from about 0 μm to about 150 μm, for example from about 0 μm to about 50 μm.

In further examples, the lateral distance “Ld” can be within a range of from about 50 μm to about 750 μm, for example from about 50 μm to about 650 μm, for example from about 50 μm to about 550 μm, for example from about 50 μm to about 450 μm, for example from about 50 μm to about 350 μm, for example from about 50 μm to about 250 μm, for example from about 50 μm to about 150 μm.

In still further examples, the lateral distance “Ld” can be within a range of from about 150 μm to about 750 μm, for example from about 150 μm to about 650 μm, for example from about 150 μm to about 550 μm, for example from about 150 μm to about 450 μm, for example from about 150 μm to about 350 μm, for example from about 150 μm to about 250 μm.

In additional examples, the lateral distance “Ld” can be within a range of from about 250 μm to about 750 μm, for example from about 250 μm to about 650 μm, for example from about 250 μm to about 550 μm, for example from about 250 μm to about 450 μm, for example from about 250 μm to about 350 μm.

In further examples, the lateral distance “Ld” can be within a range of from about 350 μm to about 750 μm, for example from about 350 μm to about 650 μm, for example from about 350 μm to about 550 μm, for example from about 350 μm to about 450 μm.

In yet further examples, the lateral distance “Ld” can be within a range of from about 450 μm to about 750 μm, for example from about 450 μm to about 650 μm, for example from about 450 μm to about 550 μm.

In further examples, the lateral distance “Ld” can be within a range of from about 550 μm to about 750 μm, for example from about 550 μm to about 650 μm. And in further examples, the lateral distance “Ld” can be within a range of from about 650 μm to about 750 μm.

As shown in FIGS. 3 and 5, the new outer edge 207 of the flexible glass sheet 103 laterally extends beyond the outer periphery 217 of the first major surface 111 of the carrier substrate 109 as shown by “Ld” in FIGS. 3 and 5. Alternatively, as shown in FIG. 4, the outer periphery 217 of the first major surface 111 of the carrier substrate 109 laterally extends beyond the new outer edge 207 of the flexible glass sheet 103 as shown by “Ld” in FIG. 4.

Methods of the disclosure can also provide the new outer edges of the flexible glass sheet 103 with a relatively high strength. Indeed, the outer edges of the flexible glass sheet can be produced with significantly reduced flaws, cracks or other imperfections that might otherwise serve as points of crack failure. Edge strength can be measured by a conventional two-point bend test. Multiple samples may be fabricated using the same edge-forming technique. The point at which each of the samples fails can be plotted on a Weibull distribution graph. Throughout the application, the “B10 strength” of the flexible glass sheet is the mean stress of failure of the flexible glass sheets where 10% of the sample is expected to fail. Based on two point bend tests conducted on the separated outer edge portions of the flexible glass sheets, methods of the disclosure are expected to provide the flexible glass sheets with a B10 strength of at least 150 MPa, for example at least 175 MPa, for example at least 200 MPa. In some examples, the B10 strength can be from about 150 MPa to about 200 MPa, for example from about 150 MPa to about 190 MPa, for example from about 150 MPa to about 180 MPa, for example from about 150 MPa to about 170 MPa, for example from about 150 MPa to about 160 MPa.

Methods of processing a flexible glass sheet will now be described, for example, to produce the alternative embodiments of the example glass-carrier assembly 101 discussed above.

The method can begin by providing the flexible glass sheet 103 including the first major surface 105 and the second major surface 107 opposing the first major surface 105. The second major surface 107 of the flexible glass sheet 103 is temporarily bonded with respect to the first major surface 111 of the carrier substrate 109. In one example, the method can begin with the flexible glass sheet 103 already bonded with respect to the carrier substrate 109 as shown in FIG. 7. For instance, the flexible glass sheet and carrier substrate may have already been bonded previously. Alternatively, as shown in FIG. 6, the method can include the step of temporarily bonding the second major surface 107 of the flexible glass sheet 103 with respect to the first major surface 111 of the carrier substrate 109. Indeed, as discussed above for example, a layer of adhesive material 601 may be applied (e.g., to the first major surface 111 of the carrier substrate 109). The specific mechanism of temporarily bonding the second major surface 107 to the first major surface 111 is not particularly important, and does not require an adhesive material. The flexible glass sheet 103 and the carrier substrate 109 can thereafter be pressed together to bond the second major surface 107 of the flexible glass sheet 103 to the first major surface 111 of the carrier substrate 109 as shown in FIG. 7.

As shown in FIG. 6, the second major surface 107 of the flexible glass sheet 103 includes a surface area “A1” that can be larger than a surface area “A2” of the first major surface 111 of the carrier substrate 109. In fact, the flexible glass sheet 103 can be significantly oversized such that the oversized surface area of the flexible glass sheet is significantly greater than the final trimmed surface area of the flexible glass sheet. The oversized nature of the flexible glass sheet can simplify the step of bonding since exact alignment of the flexible glass sheet relative to the carrier substrate is not required. Rather, the desired relative dimensions may be provided by subsequent separation of an outer edge portion of the glass sheet after the glass sheet is mounted to the carrier substrate.

As shown in FIGS. 7 and 8, once the oversized flexible glass sheet is mounted relative to the carrier substrate, an outer edge portion 701 of the flexible glass sheet 103 protrudes beyond the outer periphery 217 of the first major surface 111 of the carrier substrate 109. Stated another way, the outer edge portion 701 of the flexible glass sheet 103 is cantilevered from the first major surface 111 of the carrier substrate 109. In some examples, the protrusion distance can be from about 15 mm to about 150 mm although other protrusion distances may be used in further examples. As further shown in hidden lines in FIG. 2, in some examples, the significant oversized nature of the flexible glass sheet allows a rough alignment between the flexible glass sheet and the carrier substrate such that the outer edge portion 701 of the flexible glass sheet 103 laterally circumscribes the first major surface 111 of the carrier substrate 109. After the bonding is complete, the outer edge portion 701 can thereafter be removed to provide precise relative dimensions between the flexible glass sheet and the carrier substrate.

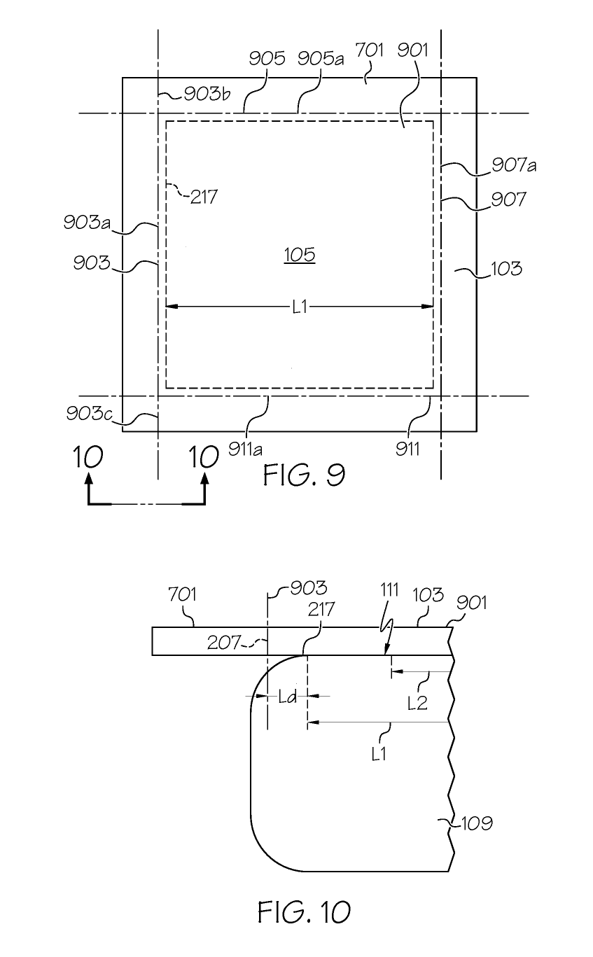

With initial reference to FIGS. 9 and 10, methods of the disclosure can further include the step of separating the outer edge portion 701 from a bonded portion 901 (temporarily bonded portion, wherein the flexible glass sheet 103 may be removed from the carrier substrate 109 after processing, for example, processing of devices onto the flexible glass sheet) of the flexible glass sheet 103 along a separation path 903, 905, 907, 911 while the bonded portion 901 of the flexible glass sheet 103 remains bonded with respect to the first major surface 111 of the carrier substrate 109. In some examples, areas of the outer edge portion 701 may be removed sequentially in segments. For instance, one side of the outer edge portion 701 may be removed by separating along the separation path 903 including a central portion 903a of the path and opposite end segments 903b, 903c of the separation path 903. Alternatively, the separation path may include a plurality of central segments 903a, 905a, 907a, 911a without one or any of the end segments. Indeed, in some examples, separation may occur along a closed separation path in the form of a circumferential ring 903a, 905a, 907a, 911a that removes a circumferential outer edge portion 701.

Once separated along the separation path, the step of separating the outer edge portion 701 provides the flexible glass sheet 103 with the new outer edge(s) 201, 203, 205, 207 extending along the separation path(s). As shown in FIG. 10, as discussed previously, the lateral distance “Ld” between the new outer edge(s) 201, 203, 205, 207 of the flexible glass sheet 103 and the outer periphery 217 of the first major surface 111 of the carrier substrate 109 can be equal to or less than about 750 μm.

Various techniques can be employed to separate the outer edge portion 701 while providing relatively high quality new outer edge(s) 201, 203, 205, 207 that provide the flexible glass sheet 103 with a desired level of strength. In one example, the method of separating can include providing at least one defect in at least one of the first major surface 105 and the second major surface 107 of the flexible glass sheet 103 on the separation path(s) 903, 905, 907, 911.

Providing the defect in the second major surface 107 can help promote separation in applications where the first major surface 105 is being heated with electromagnetic radiation (e.g., a CO₂ laser) along the separation path. Indeed, heating the first major surface 105 places the first major surface under compressive stress which results in the opposite second major surface 107 of the flexible glass sheet 103 being placed under tensile stress. As the flexible glass sheet is weaker in tension than compression, providing the defect in the second major surface 107 can promote separation. However, application of a defect in the second major surface may consequently weaken the area around the defect even after separation. There may be a desire to avoid weakness in the second major surface since the procedure of subsequently removing the flexible glass sheet may place the second major surface 107 under tensile stress. Indeed, as shown in FIG. 29, removal of the flexible glass sheet 103 may involve bending the flexible glass sheet such that the second major surface 107 of the flexible glass sheet 103 is placed in tension. As such, in another example, to avoid weakness in the second major surface 107, the at least one defect may be provided in the first major surface 105 on the separation path(s) 903, 905, 907, 911. As shown in FIG. 29, the first major surface 105 would be placed under compressive stress during a peeling procedure. As the flexible glass sheet is stronger under compression, weakness introduced by the defect in the first major surface 105 may be of relatively less concern.

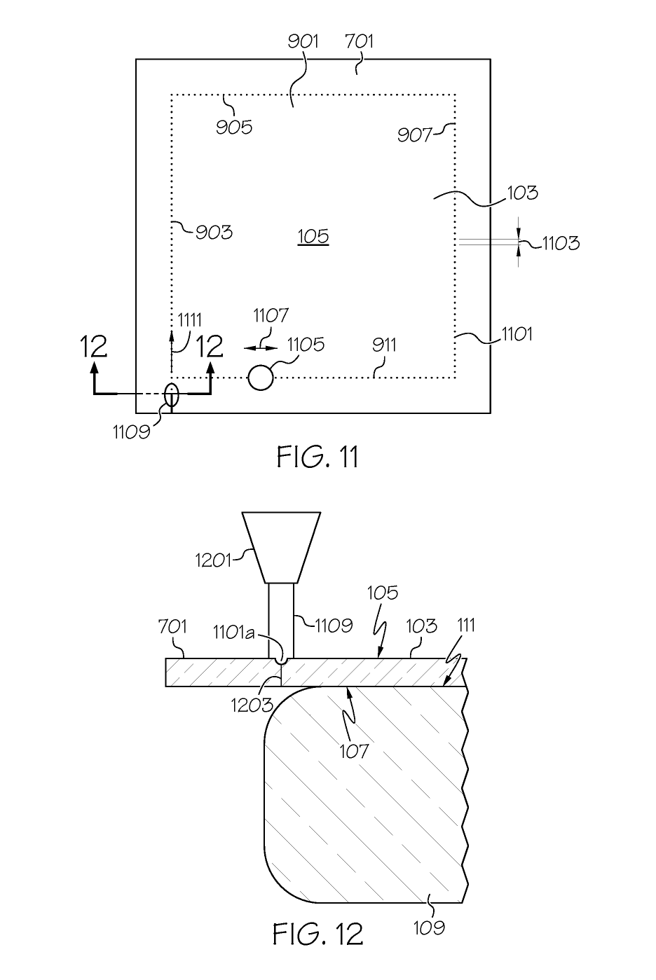

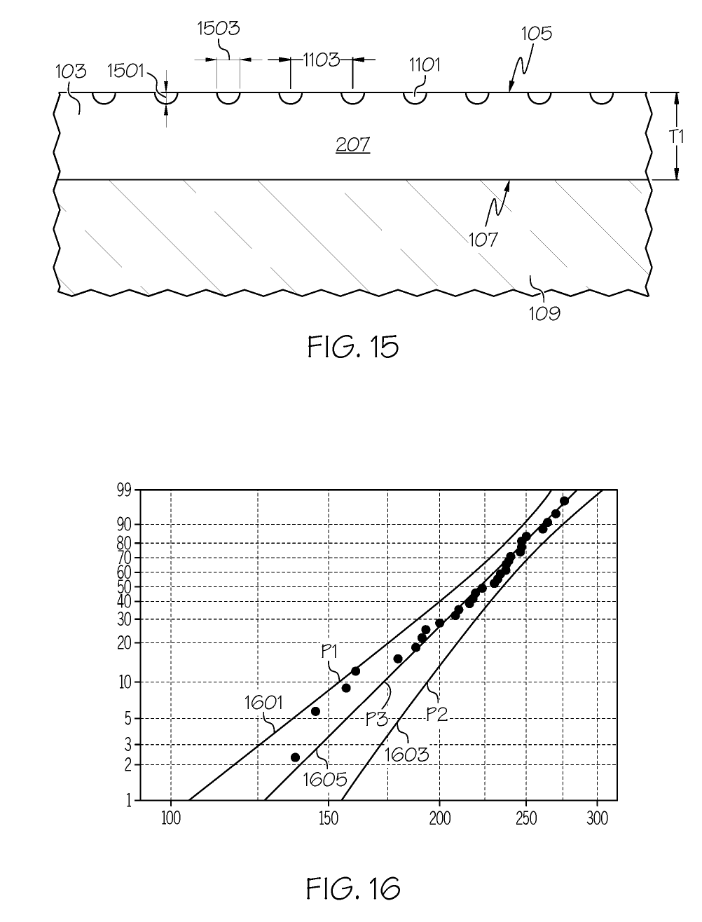

FIGS. 11-15 demonstrate just one example method of separating the outer edge portion 701 from the bonded portion 901 of the flexible glass sheet 103 along the separation paths 903, 905, 907, 911 while the bonded portion 901 of the flexible glass sheet 103 remains bonded with respect to the first major surface 111 of the carrier substrate 109. As shown in FIG. 11, the at least one defect can comprise a plurality of defects 1101 in the first major surface 105 of the flexible glass sheet 103, wherein the plurality of defects 1001 are spaced apart from one another by a distance 1103 along the separation paths 903, 905, 907, 911. In one example, the plurality of defects can be created by an ultraviolet laser 1105 configured to move along alternate directions 1107 along the separation paths 903, 905, 907, 911.

In some examples, each defect of the plurality of defects 1101 can extend from the first major surface 105 to a depth 1501 below the first major surface 105 of less than or equal to 20% of the thickness T1 of the flexible glass sheet, for example less than or equal to 10% of the thickness T1 of the flexible glass sheet. In addition or alternatively, the distance 1103 between adjacent defects of the plurality of defects 1101 is within a range of from about 15 μm to about 25 μm, for example, about 20 μm.

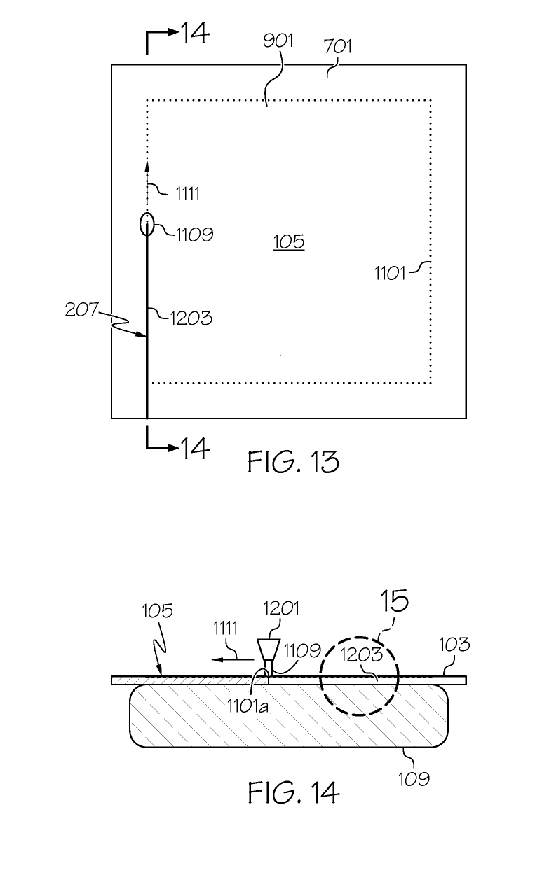

As shown in FIGS. 11-14, the method can further include the step of traversing a beam 1109 of electromagnetic radiation along a direction 1111 over the first major surface 105 of the flexible glass sheet 103 along the separation paths 903, 905, 907, 911. In one example, the electromagnetic radiation is provided by a CO₂ laser 1201 although other laser types may be used in further examples. As shown in FIG. 12, the beam 1109 of electromagnetic radiation transforms at least one defect 1101a of the plurality of defects 1101 into a full body crack 1203 intersecting the first major surface 105 and the second major surface 107 of the flexible glass sheet 103. As shown in FIGS. 13-15, the beam 1109 of electromagnetic radiation can continue to traverse along the direction 1111 over the first major surface 105 of the flexible glass sheet 103 along the separation paths 903, 905, 907, 911 to propagate the full body crack 1203 through remaining defects of the plurality of defects 1001. Once the path is complete, as shown in FIG. 2, a full body separation of the outer edge portion 701 (removed and shown in hidden lines in FIG. 2) from the bonded portion 901 of the flexible glass sheet 103 while the second major surface 107 of the flexible glass sheet 103 remains bonded to the first major surface 111 of the carrier substrate 109.

FIG. 16 is a Weibull distribution of 30 samples of separated outer edge portions 701 that were separated by methods similar to the methods shown and discussed with respect to FIGS. 11-15, and then subject to a two-point bend test. The vertical axis of the Weibull distribution is percent probability of failure and the horizontal axis is the maximum strength in MPa. As can be seen by the horizontal dashed line at 10%, the B10 strength of the separated outer edge portions 701, and consequently the expected strength of the trimmed flexible glass sheets, can be within a range of from about 150 MPa to about 200 MPa. The outer range lines 1601, 1603 intersect the 10% probability at P1 (about 154 MPa) and P2 (about 194 MPa) wherein the mean line 1605 intersects the 10% probability at P3 (about 175 MPa). The tests that produced the 30 samples of the outer edge portions used in the two-point bend test included using an ultraviolet laser to produce a plurality of defects 1101 spaced a distance 1103 of 20 μm, a diameter of 8 μm and a depth 1501 of 10 μm.

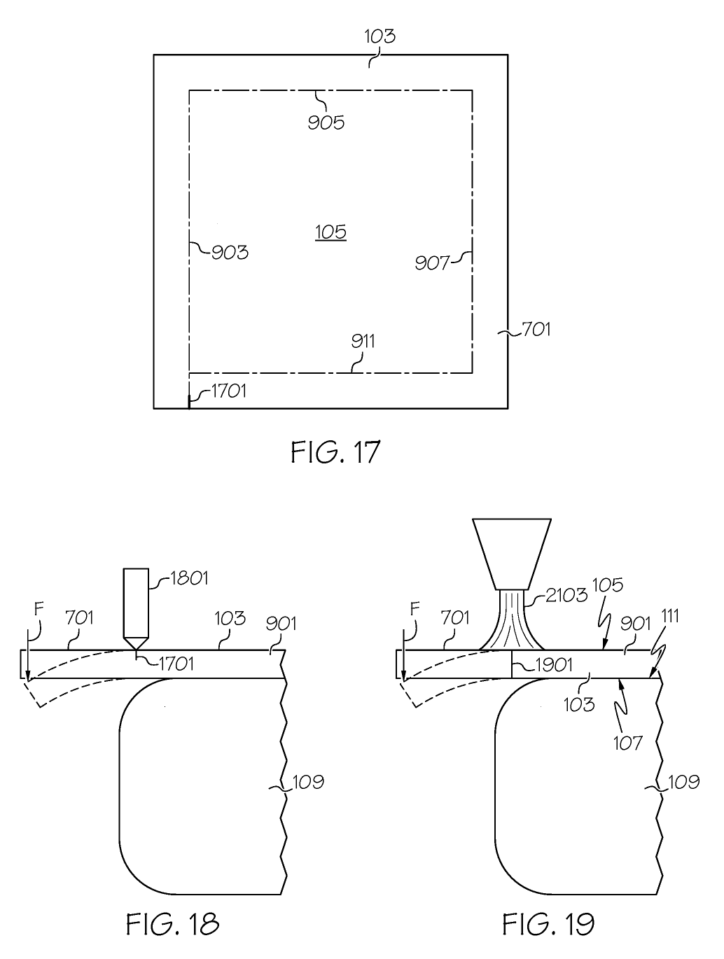

FIGS. 17-21 illustrate another example method of separating the outer edge portion 701 from the bonded portion 901 of the flexible glass sheet 103 along the separation paths 903, 905, 907, 911 while the bonded portion 901 of the flexible glass sheet 103 remains bonded with respect to the first major surface 111 of the carrier substrate 109. As shown a first defect 1701 can be provided in the first major surface 105 of the glass sheet although the first defect may be provided in the second major surface 107 in further examples. The first defect 1701 can be produced using various methods. For example, the first defect 1701 produced by a laser pulse (e.g., ultraviolet laser) or by a mechanical tool (see 1801 in FIG. 18) for example a scribe, scoring wheel, diamond tip, indenter, etc.

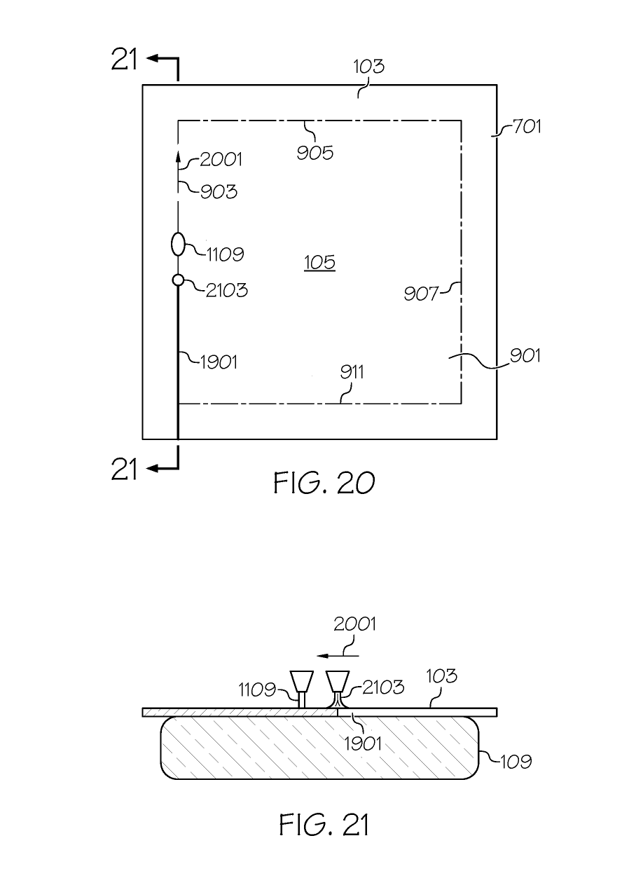

As shown in FIGS. 20-21, the method can further include the step of traversing a beam 1109 of electromagnetic radiation over the first major surface 105. The beam 1109 of electromagnetic radiation can be produced by a laser and can produce the heated region 1109 shown in FIG. 20. As further shown in FIG. 20, the beam 1109 of electromagnetic radiation is followed by a cooling stream 2103 of fluid along the separation paths 903, 905, 907, 911. The cooling fluid can comprise a liquid, gas or combination of liquid and gas. For instance, the cooling fluid can comprise a cooling stream of mist including air and water. The application of the cooling stream 2103 produces a cooled region on the first major surface 105 of the flexible glass sheet 103 that is substantially lower in temperature than the heated region produced by the beam 1109 of electromagnetic radiation. As a result of this temperature difference, a thermal stress is generated in the flexible glass sheet 103 that causes the first defect 1701 to transform into a full body crack 1901 intersecting the first major surface 105 and the second major surface 107 of the flexible glass sheet 103.

As shown in FIGS. 20 and 21, the method can traverse the beam 1109 of electromagnetic radiation followed by the cooling stream 2103 in direction 2001 to propagate the full body crack 1901 along the separation paths 903, 905, 907, 911, thereby producing a full body separation of the outer edge portion 701 from the bonded portion 901 of the flexible glass sheet 103 while the second major surface 107 of the flexible glass sheet 103 remains bonded to the first major surface 111 of the carrier substrate 109.

In some examples, the laser used to produce the beam 1109 of electromagnetic radiation can comprise a CO₂ laser. In some examples, the CO₂ laser can be operated with a power of from about 5 W to about 400 W, for example 10 W to about 200 W, for example 15 W to about 100 W, for example 20 W to 75 W. The maximum dimension of the beam spot (e.g., see elliptical spot 2101 of the beam in FIG. 20) can be within a range of from about 2 mm to about 50 mm, for example from about 2 mm to about 30 mm, for example from about 2 mm to about 20 mm, for example, from about 5 mm to about 15 mm, for example about 10 mm to about 11 mm.

Prior to or during forming the first defect 1701 or prior to or during transforming of the first defect 1701 into the full body crack 1901, as shown in hidden lines in FIGS. 18 and 19, the outer edge portion 701 may be bent relative to the bonded portion 901 of the flexible glass sheet 103 to place the first major surface 105 of the flexible glass sheet 103 along the separation path in tension. Placing the first major surface 105 in tension amplifies the significance of the first defect 1701, making it easier to transform the first defect into the full body crack or to propagate the full body crack along the separation path.

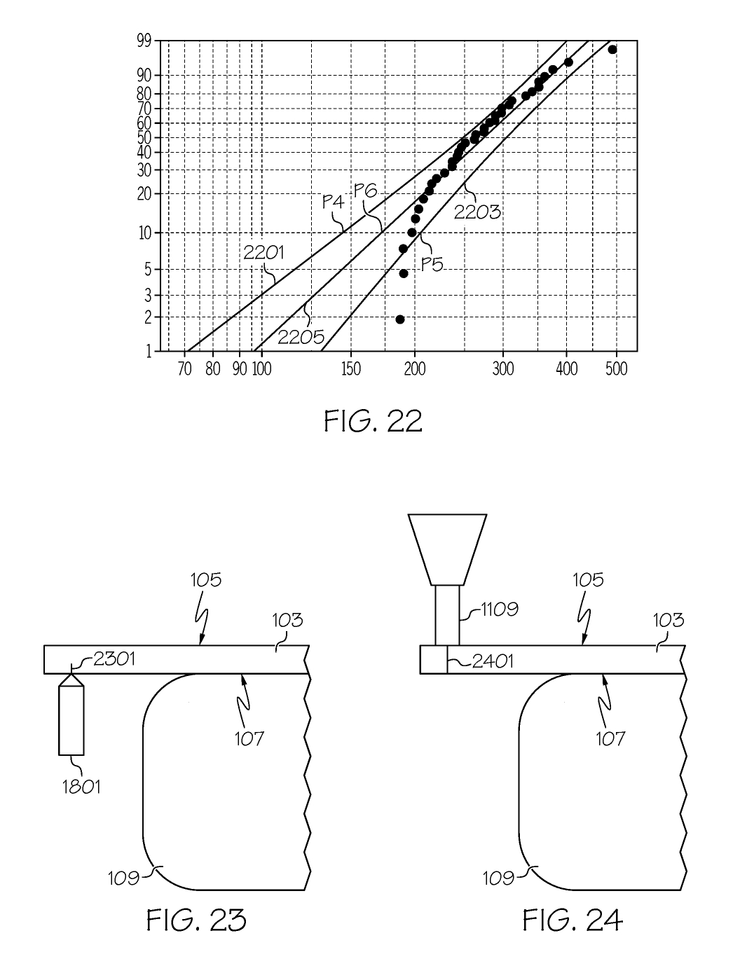

FIG. 22 is a Weibull distribution of 30 samples of separated outer edge portions 701 that were separated by methods similar to the methods shown and discussed with respect to FIGS. 17-21, and then subject to a two-point bend test. The vertical axis in the Weibull distribution is percent probability of failure and the horizontal axis is the maximum strength in MPa. As can be seen by the horizontal dashed line at 10%, the B10 strength of the separated outer edge portions 701, and consequently the expected strength of the trimmed flexible glass sheets, can be within a range of from about 125 MPa to about 225 MPa, and for example from about 150 MPa to about 200 MPa. A first outer range line 2201 intersects the 10% probability at P4 between 125 MPa and 150 MPa. A second outer range line 2203 intersects the 10% probability at P5 between 200 MPa and 250 MPa. The mean line 2205 intersects the 10% probability at P6 (about 175 MPa).

FIGS. 23-26 illustrate still another example method of separating the outer edge portion 701 from the bonded portion 901 of the flexible glass sheet 103 along the separation paths 903, 905, 907, 911 while the bonded portion 901 of the flexible glass sheet 103 remains bonded with respect to the first major surface 111 of the carrier substrate 109. As shown in FIG. 23, a defect 2301 can be formed in the second major surface 107 of the flexible glass sheet 103 rather than the first major surface 105 as shown in FIG. 18. Like the embodiment of FIG. 18, the defect can be produced using various methods. For example, the defect 2301 produced by a laser pulse (e.g., ultraviolet laser) or by the mechanical tool (see 1801 in FIG. 23) for example a scribe, scoring wheel, diamond tip, indenter, etc.

As the defect 2301 of FIG. 23 is formed in the second major surface 107, the cooling stream of FIGS. 20-21 may not be necessary. Indeed, as mentioned previously, heating the first major surface 105 can cause tension in the second major surface. Such tension resulting from traversing the beam 1109 of electromagnetic radiation over the first major surface 105 may be sufficient alone to transform the defect 2301 into a full body crack 2401 (see FIG. 24) intersecting the first major surface 105 and the second major surface 107 of the flexible glass sheet 103.

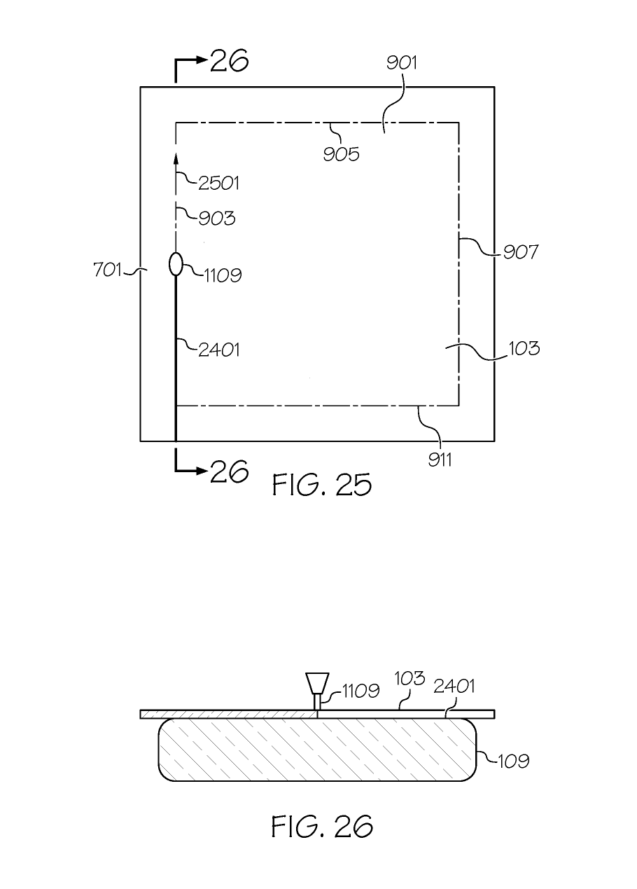

As shown in FIG. 25 the method can traverse a beam 1109 of electromagnetic radiation in direction 2501 to propagate the full body crack 2401 along the separation paths 903, 905, 907, 911, thereby producing a full body separation of the outer edge portion 701 from the bonded portion 901 of the flexible glass sheet 103 while the second major surface 107 of the flexible glass sheet 103 remains bonded to the first major surface 111 of the carrier substrate 109.

In some examples, the laser used to produce the beam 1109 of electromagnetic radiation can comprise a CO₂ laser. In some examples, the CO₂ laser can be operated with a power of from about 5 W to about 400 W, for example 10 W to about 200 W, for example 15 W to about 100 W, for example 50 W to 80 W, for example 20 W to 75 W. The maximum dimension of the beam spot (e.g., see elliptical spot 2101 of the beam in FIG. 25) can be within a range of from about 2 mm to about 50 mm, for example from about 2 mm to about 30 mm, for example from about 2 mm to about 20 mm, for example, from about 5 mm to about 15 mm, for example about 10 mm to about 11 mm.

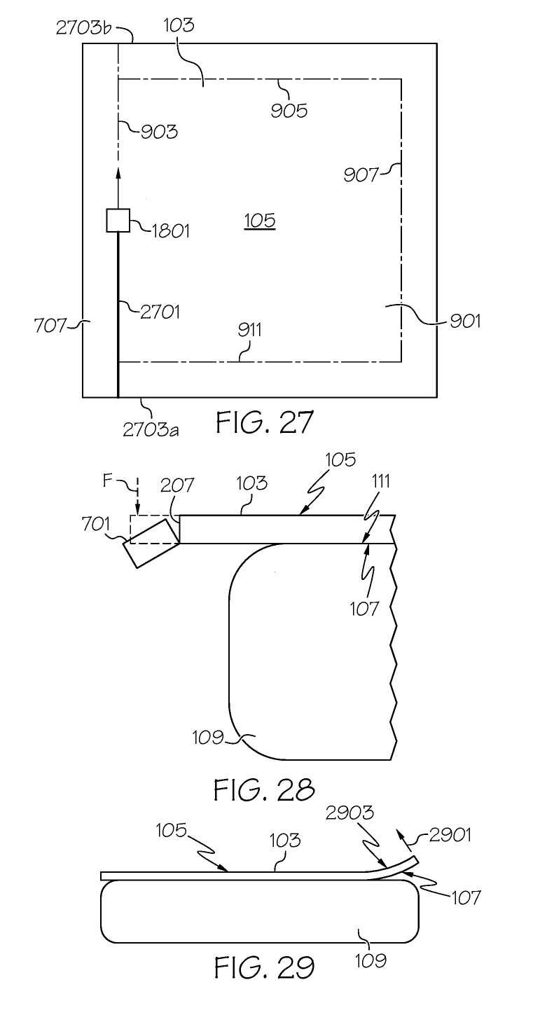

FIGS. 27 and 28 illustrate yet another example method of separating the outer edge portion 701 from the bonded portion 901 of the flexible glass sheet 103 along the separation paths 903, 905, 907, 911 while the bonded portion 901 of the flexible glass sheet 103 remains bonded with respect to the first major surface 111 of the carrier substrate 109. As shown, the at least one defect can comprise a scribe line 2701 in the first major surface 105 of the flexible glass sheet 103 along the separation path 903. The scribe line 2701 may extend over a substantial distance, for example the entire distance, between opposed edges 2703a, 2703b and may be produced by a laser pulse (e.g., ultraviolet laser) or by a mechanical tool (see 1801 in FIG. 27) for example a scribe, scoring wheel, diamond tip, indenter, etc.

As shown in FIG. 28, the method can further apply a bending force “F” to the outer edge portion 701 to separate the outer edge portion 701 from the bonded portion 901 of the flexible glass sheet 103. Producing a scribe line along a substantial distance, for example the entire distance, between opposed edges can result in corresponding damage that may reduce bending strength of the flexible glass sheet. However, since the damage is limited to the first major surface 105, the weakened areas may not manifest itself in failure during subsequent peeling of the flexible glass sheet 103 from the carrier substrate 109.

As shown in FIG. 29, sometime after separating the outer edge portion(s) from the bonded portion 901 of the flexible glass sheet 103, the method can optionally include the step of releasing at least a portion of the flexible glass sheet 103 from the carrier substrate 109 by producing a concave curvature 2903 in the first major surface 105 of the flexible glass sheet 103. The concave curvature 2903 results in the first major surface 105 being placed in compression, thereby minimizing any weakening along the first major surface 105 of the flexible glass sheet 103 that may have occurred when forming the scribe line 2701. In just one example a force 2901 may be applied to an edge portion of the flexible glass sheet 103 to promote initial or entire peeling of the flexible glass sheet from the carrier substrate.

After forming the glass-carrier assembly 101 of FIGS. 1-4 and before debonding the flexible glass sheet as shown in FIG. 29, the flexible glass sheet 103 may undergo further processing techniques. For example, liquid crystal growth, thin film deposition, polarizer bond or other techniques may be performed. Moreover, the flexible glass sheet 103 may temporarily be supported by the relatively rigid carrier substrate to facilitate processing of the flexible glass sheet with current manufacturing processes and devices configured to handle relatively rigid and relatively thick glass sheet.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A method of processing a flexible glass sheet comprising:
(I) providing a flexible glass sheet including a first major surface and a second major surface opposing the first major surface, wherein the second major surface of the flexible glass sheet is bonded with respect to a first major surface of a carrier substrate and an outer edge portion of the flexible glass sheet protrudes beyond an outer periphery of the first major surface of the carrier substrate, and a thickness between the first major surface and the second major surface of the flexible glass sheet is equal to or less than about 300 μm; and then
(II) separating the outer edge portion from a bonded portion of the flexible glass sheet along a separation path while the bonded portion of the flexible glass sheet remains bonded with respect to the first major surface of the carrier substrate, wherein the step of separating the outer edge portion provides the flexible glass sheet with a new outer edge extending along the separation path, wherein a lateral distance between the new outer edge of the flexible glass sheet and the outer periphery of the first major surface of the carrier substrate is equal to or less than about 750 μm.

2. The method of claim 1, wherein step (I) further includes bonding the second major surface of the flexible glass sheet with respect to the first major surface of the carrier substrate, wherein the second major surface of the flexible glass sheet being bonded during step (I) has a larger surface area than a surface area of the first major surface of the carrier substrate.

3. The method of claim 2, wherein bonding during step (I) laterally circumscribes the first major surface of the carrier substrate with the outer edge portion of the flexible glass sheet.

4. The method of claim 1, wherein step (II) includes providing at least one defect in at least one of the first major surface and the second major surface of the flexible glass sheet on the separation path.

5. The method of claim 4, wherein the at least one defect comprises a plurality of defects in the first major surface of the flexible glass sheet, and the plurality of defects are spaced apart from one another along the separation path.

6. The method of claim 5, wherein each defect of the plurality of defects extends from the first major surface to a depth below the first major surface of less than or equal to 20% of the thickness of the flexible glass sheet.

7. The method of claim 5, wherein the space between adjacent defects of the plurality of defects is within a range of from about 15 μm to about 25 μm.

8. The method of claim 5, wherein step (II) further includes traversing a beam of electromagnetic radiation over the first major surface along the separation path to:
(a) transform at least one of the plurality of defects into a full body crack intersecting the first major surface and the second major surface of the flexible glass sheet; and
(b) propagate the full body crack through remaining defects of the plurality of defects along the separation path, thereby producing a full body separation of the outer edge portion from the bonded portion of the flexible glass sheet while the second major surface of the flexible glass sheet remains bonded to the first major surface of the carrier substrate.

9. The method of claim 4, wherein the at least one defect is provided in the second major surface of the flexible glass sheet and step (II) further includes traversing a beam of electromagnetic radiation over the first major surface along the separation path to:
(a) transform the at least one defect into a full body crack intersecting the first major surface and the second major surface of the flexible glass sheet; and
(b) propagate the full body crack along the separation path, thereby producing a full body separation of the outer edge portion from the bonded portion of the flexible glass sheet while the second major surface of the flexible glass sheet remains bonded to the first major surface of the carrier substrate.

10. The method of claim 4, wherein step (II) further includes traversing a beam of electromagnetic radiation over the first major surface followed by a cooling stream of fluid along the separation path to:
(a) transform the at least one defect into a full body crack intersecting the first major surface and the second major surface of the flexible glass sheet; and
(b) propagate the full body crack along the separation path, thereby producing a full body separation of the outer edge portion from the bonded portion of the flexible glass sheet while the second major surface of the flexible glass sheet remains bonded to the first major surface of the carrier substrate.

11. The method of claim 10, wherein the at least one defect is provided in the first major surface of the flexible glass sheet.

12. The method of claim 4, wherein the at least one defect comprises a scribe line in the first major surface of the flexible glass sheet along the separation path and wherein step (II) further includes applying a bending force to the outer edge portion to separate the outer edge portion from the bonded portion of the flexible glass sheet.

13. The method of claim 1, wherein during step (II), the outer edge portion is bent relative to the bonded portion of the flexible glass sheet to place the first major surface of the flexible glass sheet along the separation path in tension.

14. The method of claim 1, wherein the new outer edge of the flexible glass sheet has a B10 strength within a range of from about 150 MPa to about 200 MPa.

15. The method of claim 1, wherein the new outer edge of the flexible glass sheet laterally extends beyond the outer periphery of the first major surface of the carrier substrate.

16. The method of claim 1, wherein the outer periphery of the first major surface of the carrier substrate laterally extends beyond the new outer edge of the flexible glass sheet.

17. The method of claim 1, wherein the outer periphery of the first major surface of the carrier substrate laterally extends beyond the new outer edge of the flexible glass sheet by a distance up to about 250 μm.

18. The method of claim 1, wherein step (I) provides the second major surface of the flexible glass sheet with a larger surface area than a surface area of the first major surface of the carrier substrate.

19. The method of claim 18, wherein step (I) provides that the outer edge portion of the flexible glass sheet laterally circumscribes the first major surface of the carrier substrate.

20. The method of claim 1, wherein after step (II), further comprising the step (III) of releasing at least a portion of the flexible glass sheet from the carrier substrate by producing a concave curvature in the first major surface of the flexible glass sheet.

21. A glass-carrier assembly comprising:
a flexible glass sheet comprising a first major surface and a second major surface opposing the first major surface, a thickness between the first major surface and the second major surface equal to or less than 300 μm;
a carrier substrate comprising a first major surface and a second major surface opposing the first major surface of the carrier substrate, and a perimeter, the first major surface of the carrier substrate being temporarily bonded to the second major surface of the flexible glass sheet,
wherein either the flexible glass sheet is smaller than the carrier substrate by up to 750 microns at each point around the perimeter, or the carrier is smaller than the flexible glass sheet by up to 750 microns at each point around the perimeter.

22. The assembly of claim 21, wherein the new outer edge of the flexible glass sheet has a B10 strength within a range of from about 150 MPa to about 200 MPa.

23. The assembly of claim 21, wherein the new outer edge of the flexible glass sheet laterally extends beyond the outer periphery of the first major surface of the carrier substrate.

24. The method of claim 21, wherein the outer periphery of the first major surface of the carrier substrate laterally extends beyond the new outer edge of the flexible glass sheet.

25. The method of claim 21, wherein either the outer periphery of the first major surface of the carrier substrate laterally extends beyond the new outer edge of the flexible glass sheet by a distance up to about 250 μm, or the new outer edge of the flexible glass sheet laterally extends beyond the outer periphery of the first major surface of the carrier substrate by a distance up to about 250 μm.
